(19) United States
(12) Patent Application Publication
(10) Pub. No.: US 2023/0122894 A1
(43) Pub. Date: Apr. 20, 2023

(54) POINT MANAGEMENT PROGRAM, POINT MANAGEMENT SYSTEM, AND POINT MANAGEMENT METHOD

(71) Applicants: Square Enix Co., Ltd., Tokyo (JP); double jump.tokyo Inc., Tokyo (JP)

(72) Inventors: Keisuke HATA, Tokyo (JP); Koichi SAITO, Tokyo (JP); Takehiro NAKAKURA, Tokyo (JP); Yudai KAWAMURA, Tokyo (JP); Ryo MANZOKU, Tokyo (JP); Yukinori MATSUYA, Tokyo (JP)

(21) Appl. No.: 18/046,390

(22) Filed: Oct. 13, 2022

(30) Foreign Application Priority Data
Oct. 13, 2021 (JP) 2021-167948

(51) Int. Cl. G06Q 20/36

(52) U.S. Cl. CPC G06Q 20/3672; G06Q 2220/00

(57) ABSTRACT

[Object] Usage of token is expanded and user satisfaction is improved.

[Solution] A point management program causes a computer to implement a point accumulation function of accumulating points associated with a token corresponding to a user, according to a predetermined condition.

### TECHNICAL FIELD

At least one embodiment of the present invention relates to a point management program, a point management system, and a point management method.

### BACKGROUND ART

Technologies using various tokens such as non-fungible tokens (NFTs) using blockchains have emerged.

Patent Literature 1 describes a game system capable of transmitting and receiving in-game non-fungible assets in a game played by a user as NFTs between in-game and out-of-game. The game system includes a game management unit that manages a game, an asset management unit that manages in-game non-fungible assets, and a management-side wallet unit that designates with a user's wallet unit, each other's addresses, and transmits and receives NFTs by storing the NFTS on the blockchain via a network. When transmitting in-game non-fungible assets to outside the game, the asset management unit deletes the owner information on the in-game non-fungible assets, and the management-side wallet unit issues the in-game non-fungible assets as NFT, and transmits the NFT to the wallet address designated by the user.

### CITATION LIST

### Patent Literature

[Patent Literature 1] JPA2021-152815

### SUMMARY OF INVENTION

### Technical Problem

However, tokens such as NFT can be associated with various types of digital data such as characters and items in games, electronic seals, and digital images.

By adding points, which can be accumulated, to the token, it is possible to expand the usage of the token and improve user satisfaction.

An object of at least one embodiment of the present invention is to solve the above problems, expand the usage of tokens, and improve user satisfaction.

### Solution to Problem

From a non-limiting point of view, a point management program according to an embodiment of the present invention is a point management program causing a computer to implement a point accumulation function of accumulating points associated with a token corresponding to a user, according to a predetermined condition.

From a non-limiting point of view, a point management system according to an embodiment of the present invention is a point management system equipped with a communication network, a server, and a user terminal, the system including point accumulation means for accumulating points associated with a token corresponding to a user, according to a predetermined condition.

From a non-limiting point of view, a point management method according to an embodiment of the present invention is a point management method by a computer, the method including a point accumulation process of accumulating points associated with a token corresponding to a user, according to a predetermined condition.

### Advantageous Effects of Invention

Embodiments of the present application address one or more deficiencies.

### BRIEF DESCRIPTION OF DRAWINGS

FIG. 1 is a block diagram showing an example of the configuration of a point management system corresponding to at least one embodiment of the present invention.

FIG. 2 is a block diagram showing the configuration of a server corresponding to at least one embodiment of the present invention.

FIG. 3 is a flow chart showing a processing example of a point management program corresponding to at least one embodiment of the present invention.

FIG. 4 is a block diagram showing the configuration of a server corresponding to at least one embodiment of the present invention.

FIG. 5 is a flow chart showing a processing example of a point management program corresponding to at least one embodiment of the present invention.

FIG. 6 is a block diagram showing the configuration of a server corresponding to at least one embodiment of the present invention.

FIG. 7 is a flow chart showing a processing example of a point management program corresponding to at least one embodiment of the present invention.

FIG. 8 is a block diagram showing an example of the configuration of a point management system corresponding to at least one embodiment of the present invention.

FIG. 9 is a block diagram showing the configuration of a point management system corresponding to at least one embodiment of the present invention.

FIG. 10 is a flow chart showing a processing example of a point management program corresponding to at least one embodiment of the present invention.

FIG. 11 is a block diagram showing the configuration of a user terminal corresponding to at least one embodiment of the present invention.

FIG. 12 is a flow chart showing a processing example of a point management program corresponding to at least one embodiment of the present invention.

FIG. 13 is a block diagram showing the configuration of a server corresponding to at least one embodiment of the present invention.

FIG. 14 is a sequence diagram showing a processing example corresponding to at least one embodiment of the present invention.

FIG. 15 is a conceptual diagram illustrating an object corresponding to a token, according to at least one embodiment of the present invention.

FIG. 16 is a conceptual diagram illustrating a customization process of content to be tokenized, according to at least one embodiment of the present invention.

FIG. 17 is a conceptual diagram illustrating a holder, according to at least one embodiment of the present invention.

FIG. 18 is a conceptual diagram showing a use example of points, according to at least one embodiment of the present invention.

### DESCRIPTION OF EMBODIMENTS

Hereinafter, examples of embodiments of the present invention will be described with reference to the drawings. It should be noted that the various constituent elements in the examples of embodiments described below can be appropriately combined within a range in which contradiction or the like does not occur. Further, with respect to the content described as an example of a certain embodiment, the description thereof may be omitted in other embodiments. Further, the contents of operations and processes that are not related to the features of each embodiment may be omitted. Further, the order of various processes configuring various flows and sequences described below is random as long as there is no contradiction in the processing contents.

### First Embodiment

An overview of a first embodiment of the present invention will be described. A point management program executed in a server, which is an example of a computer, will be described below as an example of the first embodiment.

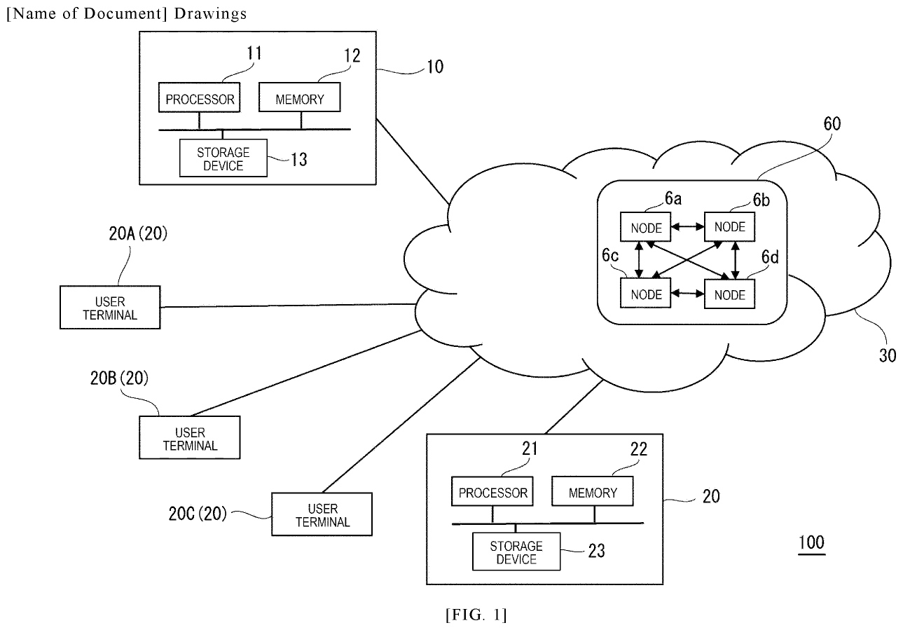

FIG. 1 is a block diagram showing an example of the configuration of a point management system 100 corresponding to at least one embodiment of the present invention. The point management system 100 includes a server 10, and user terminals 20 used by users of the point management system 100. User terminals 20A, 20B, and 20C are examples of user terminals 20, respectively. The configuration of the point management system 100 is not limited to this. For example, the point management system 100 may have a configuration in which a single user terminal is used by a plurality of users. The point management system 100 may have a plurality of servers.

The server 10 and the user terminal 20 are examples of computers. The server 10 and the user terminal 20 are communicably connected to a communication network 30 such as the Internet. The connection between the communication network 30 and the server 10 and the connection between the communication network 30 and the user terminal 20 may be wired or wireless. For example, the user terminal 20 may connect to the communication network 30 by performing data communication with a base station managed by a communication carrier through a wireless communication line.

The point management system 100 includes the server 10 and the user terminal 20, thereby achieving various functions for executing various processes according to user operations.

The server 10 may be a game processing server that controls the progress of a game. In this case, the server 10 controls the progress of the game according to the player's operation.

The server 10 includes a processor 11, a memory 12, and a storage device 13. The processor 11 is, for example, a central processing unit (CPU) that performs various calculations and controls. Further, when the server 10 includes a graphics processing unit (GPU), the GPU may perform some of the various calculations and controls. The server 10 uses the data read out to the memory 12 to execute various types of information processes in the processor 11, and stores the obtained processing results in the storage device 13 as necessary.

The storage device 13 has a function as a storage medium for storing various types of information. The configuration of the storage device 13 is not particularly limited, but from the viewpoint of reducing the processing load on the user terminal 20, it may be configured to store all the various types of information necessary for the control performed by the point management system 100. Examples of such include HDDs and SSDs. However, the storage device for storing various types of information may include a storage area that can be accessed by the server 10, and may be configured to have a dedicated storage area outside the server 10, for example.

The server 10 may be configured by an information processing apparatus such as a game processing server capable of rendering game images.

The user terminal 20 is managed by the user. Examples of the user terminal 20 include mobile phone terminals, smart phones, personal digital assistants (PDAs), personal computers, tablets, stationary game devices, and portable game devices. The user terminal 20 may be user-operable VR goggles, AR glasses, smart glasses, AR contacts, or other wearable devices.

The user terminal may be a communication terminal capable of playing games distributed via a network.

The user terminal 20 is connected to the communication network 30, and includes hardware and software for executing various processes by communicating with the server 10. The plurality of user terminals 20 may be configured to be able to directly communicate with each other without going through the server 10.

The user terminal 20 may have a built-in display device. Further, a display device may be wirelessly connected or wired to the user terminal 20. It should be noted that the display device has a very general configuration, so illustration is omitted here. When the user plays a game using the user terminal 20, the game screen is displayed as a composite image on the display device, and the user recognizes this composite image. When the user performs various types of information processes using the user terminal 20, a screen necessary for information processes (information processing screen) is displayed as an image by the display device, and the user recognizes this image. The game screen and the information processing screen are displayed, for example, on a display, which is an example of a display device provided in the user terminal, or a display, which is an example of a display device connected to the user terminal. Examples of the display device include a hologram display device capable of displaying a hologram, a projection device for projecting an image (including a game screen and an information processing screen) on a screen or the like, and an XR display device. XR includes Virtual Reality (VR), Augmented Reality (AR), Mixed Reality (MR), and Substitutional Reality (SR).

The user terminal 20 includes a processor 21, a memory 22, and a storage device 23. The processor 21 is, for example, a central processing unit (CPU) that performs various calculations and controls. Further, when the user terminal 20 includes a graphics processing unit (GPU), the GPU may perform some of the various calculations and controls. The user terminal 20 uses the data read out to the memory 22 to execute various types of information processes in the processor 21, and stores the obtained processing results in the storage device 23 as necessary. The storage device 23 has a function as a storage medium for storing various types of information.

The user terminal 20 may have a built-in input device. Further, an input device may be wirelessly connected or wired to the user terminal 20. The input device receives an operation input by a user. A processor provided in the server 10 or a processor provided in the user terminal 20 executes various control processes in response to an operation input by the user. Examples of input devices include touch panel screens of smart phones, tablets, or the like, keyboards, mice, game pads, joysticks, and other controllers. A camera built in or connected to the user terminal 20 may also correspond to the input device. The user performs operation input by gestures such as moving a hand in front of the camera (gesture input).

In addition, the user terminal 20 may be equipped with other output devices such as speakers. Other output devices output sounds, vibrations, and various other types of information to the user.

The communication network 30 includes a blockchain network 60. The blockchain network 60 is constructed by a plurality of nodes such as computers. As an example of the plurality of nodes, nodes 6a, 6b, 6c, and 6d, each being a computer, are shown in FIG. 1. These are merely examples, and the number of nodes need not be four. Note that the blockchain network 60 may be constructed as a network separate from the shown communication network 30.

The plurality of nodes 6a to 6d are typically interconnected in a peer-to-peer fashion to form the blockchain network 60. A distributed ledger is stored in the storage device of each node. The server 10 or the user terminal 20 may be communicably connected to the blockchain network 60. The server 10 or the user terminal 20 may function as a node included in the blockchain network 60.

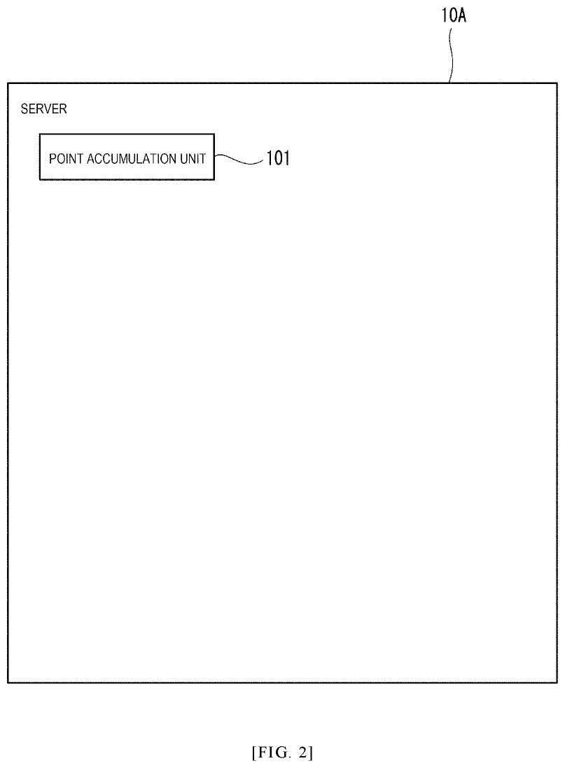

FIG. 2 is a block diagram showing the configuration of a server corresponding to at least one embodiment of the present invention. A server 10A, which is an example of the configuration of the server 10, includes at least a point accumulation unit 101. The processor provided in the server 10A functionally implements the point accumulation unit 101 by referring to the point management program stored in the storage device and executing the program.

The point accumulation unit 101 has a function of accumulating points associated with a token corresponding to a user, according to a predetermined condition.

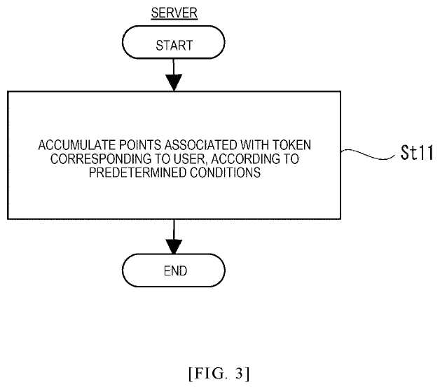

Next, a program execution process according to the first embodiment of the present invention will be described. FIG. 3 is a flow chart showing a processing example of a point management program corresponding to at least one embodiment of the present invention.

The point accumulation unit 101 accumulates points associated with a token corresponding to a user, according to predetermined conditions (St11).

A token typically means a non-fungible token (NFT). The token may be a fungible token (FT), a re-fungible token (RFT), or the like, as long as there is no contradiction.

The token corresponding to a user means a token issued by the user or a token owned by the user via purchase or transfer of the token. The token owned by a user means a token in which identification information for identifying the user has been written into the distributed ledger of the blockchain network as the current owner of the token. In addition, during the period when transaction information is managed off-chain, the token owned by the user may mean the token that the system manages the token owner information off-chain assuming that the user is the current owner of the token.

The point associated with a token means a digital value, which can be accumulated, stored in a storage device in association with the token.

The point associated with a token is not the token itself. For example, when the type of a token is a fungible token such as a crypto asset (virtual currency), the points associated with the token are not the crypto asset (virtual currency) itself.

The points associated with the token are managed as separate data from the crypto assets (virtual currencies) that back the token. For example, when a user or system operator converts digital assets such as shields and swords into NFTs, the issued NFTs may include crypto assets (virtual currencies) as backup. When the owner burns this NFT, the owner can obtain some or all of the crypto assets (virtual currencies) that were backed. The points associated with a token in the present embodiment mean values that are added to the token and managed, which are different from such a crypto asset (virtual currency) or the like.

The points associated with the token may not be associated with the user or the player character handled by the user in the game. For example, the points associated with the token are values managed as data separate from the player character's level, experience value, and the like.

The predetermined condition may be, for example, a condition of accumulating one point at 8:00 every morning, but is not limited to this.

As one aspect of the first embodiment, it is possible to expand the usage of tokens and improve user satisfaction.

### Second Embodiment

An overview of a second embodiment of the present invention will be described. A point management program executed in a server, which is an example of a computer, will be described below as an example of the second embodiment. Note that the server may be the server 10 included in the point management system 100 shown in FIG. 1.

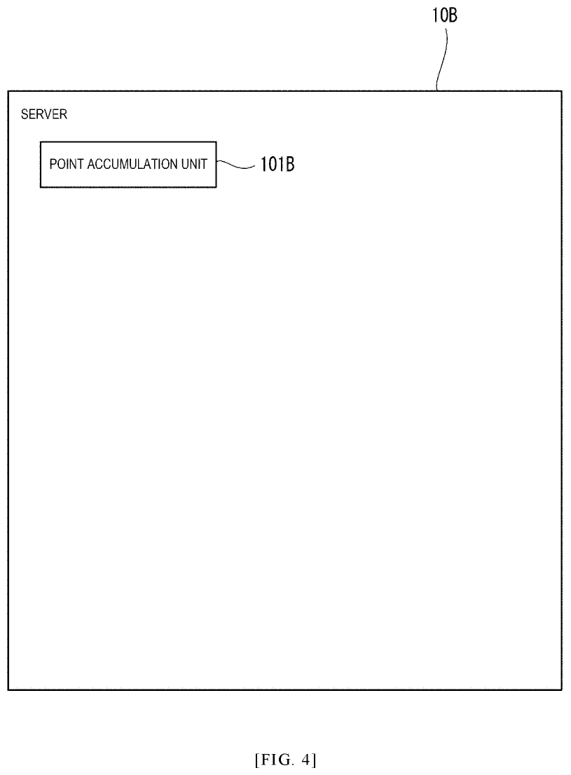

FIG. 4 is a block diagram showing the configuration of a server corresponding to at least one embodiment of the present invention. A server 10B, which is an example of the configuration of the server 10, includes at least a point accumulation unit 101B. The processor provided in the server 10B functionally implements the point accumulation unit 101B by referring to the point management program stored in the storage device and executing the program.

The point accumulation unit 101B has a function of accumulating points associated with a token corresponding to a user, according to predetermined conditions. The point accumulation unit 101B accumulates points when accumulation of points for the token is permitted.

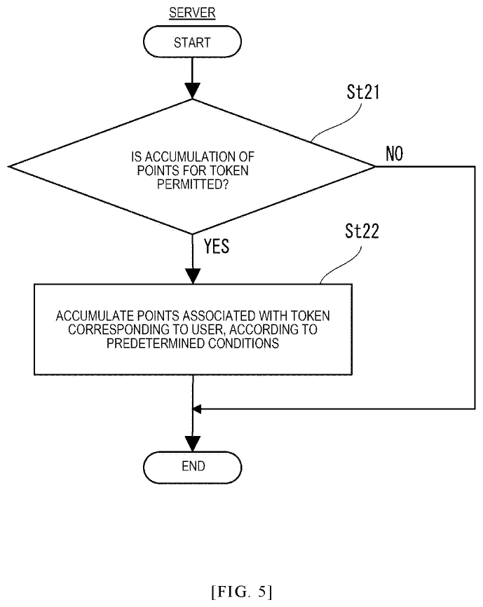

Next, a program execution process according to the second embodiment of the present invention will be described. FIG. 5 is a flow chart showing a processing example of a point management program corresponding to at least one embodiment of the present invention.

The point accumulation unit 101B determines whether accumulation of points for the token is permitted (St21). When accumulation of points for the token is permitted (St21: YES), the point accumulation unit 101B accumulates points associated with the token corresponding to the user, according to a predetermined condition (St22). When accumulation of points for the token is not permitted (St21: NO), the process shown in FIG. 5 ends.

Since the meanings of the token, the token corresponding to the user, the point associated with the token, and the predetermined condition are the same as in the first embodiment, the description is omitted from the viewpoint of avoiding duplication.

The case where accumulation of points for the token is permitted means, for example, the case where the point accumulation permission flag managed by the server 10B or the user terminal 20 for the token is on. Various conditions for turning the point accumulation permission flag from off (for example, value=0) to on (for example, value=1) are conceivable according to specifications. For example, when an electronic seal with a character drawn is converted into an NFT, the point management system 100 may change the point accumulation permission flag from off to on, when the NFT electronic seal is set in a predetermined holder described later. The point management system 100 may control on/off of the point accumulation permission flag based on other conditions.

The point management system 100 separately manages permission and non-permission of point accumulation for each token. However, the point management system 100 may collectively manage permission and non-permission of point accumulation for each group composed of a plurality of tokens.

As one aspect of the second embodiment, it is possible to flexibly control whether to accumulate points for each token.

### Third Embodiment

An overview of a third embodiment of the present invention will be described. A point management program executed in a server, which is an example of a computer, will be described below as an example of the third embodiment. Note that the server may be the server 10 included in the point management system 100 shown in FIG. 1.

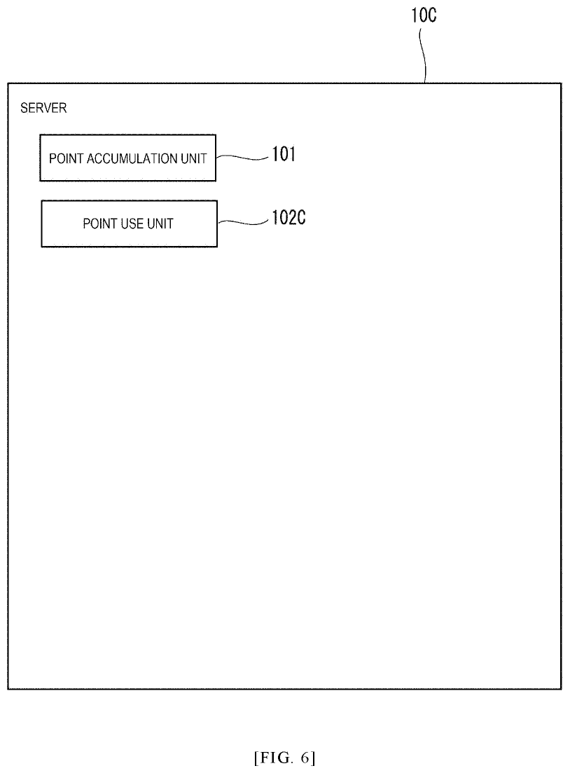

FIG. 6 is a block diagram showing the configuration of a server corresponding to at least one embodiment of the present invention. A server 10C, which is an example of the configuration of the server 10, includes at least a point accumulation unit 101 and a point use unit 102C. The processor provided in the server 10C functionally implements the point accumulation unit 101 and the point use unit 102C by referring to the point management program stored in the storage device and executing the program.

The point accumulation unit 101 has a function of accumulating points associated with a token corresponding to a user, according to a predetermined condition. The point use unit 102C has a function of using points accumulated in association with the token.

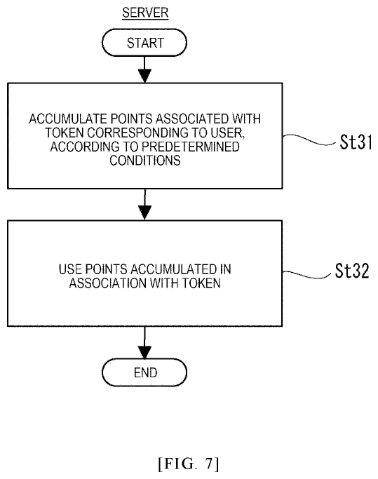

Next, a program execution process according to the third embodiment of the present invention will be described. FIG. 7 is a flow chart showing a processing example of a point management program corresponding to at least one embodiment of the present invention.

The point accumulation unit 101 accumulates points associated with a token corresponding to a user, according to predetermined conditions (St31). The point use unit 102C uses the points accumulated in association with the token (St32).

Since the meanings of the token, the token corresponding to the user, the point associated with the token, and the predetermined condition are the same as in the first embodiment, the description is omitted from the viewpoint of avoiding duplication.

Using the accumulated points means using the accumulated points for some purpose. The use of the accumulated points is not limited, but for example, the accumulated points may be used to change the attribute value of the object or content data corresponding to the token according to the points accumulated in association with the token. Accumulated points may be used for other purposes. Note that when points are used, the balance of accumulated points may or may not decrease.

The object corresponding to the token means a virtual object such as NFT characters and items. Specific examples of virtual objects include, but are not limited to, people, living things, machines, vehicles, walls, buildings, towns, landforms, and stars that can be displayed in virtual space.

The object corresponding to the token may be a real object that is present in a real space. For example, when a virtual sword is converted into an NFT, the object corresponding to the token may be a sword toy or the like that is actually made to imitate the virtual sword.

The object corresponding to the token may be an electronic seal on which the above-described object is drawn, an electronic card, or the like.

The attribute values of an object are parameter values of the attribute possessed by the object, for example, physical strength, offensive power, magical power, or the like of the character object. The parameters are typically expressed as numerical values, but the parameters may also be expressed as characters, such as offensive power SS and defensive power A. The attribute value of an object is not limited to these. A change in the attribute value may be an increase or decrease in the attribute value.

Content data corresponding to a token means, for example, image data corresponding to one frame when one frame of a four-frame cartoon is tokenized. Note that the content data is not limited to one frame of a four-frame cartoon, and various types of content data such as image data, audio data, and moving image data are conceivable.

The attribute value of the content data may refer to the attribute value of any object related to the content. Further, the attribute value of the content data may mean the attribute value of the content itself.

As one aspect of the third embodiment, by making it possible to use the points accumulated in association with the token, it is possible to expand the range of utilization of tokens and provide new enjoyment to users.

### Fourth Embodiment

An overview of a fourth embodiment of the present invention will be described. A point management system will be described below as an example of the fourth embodiment.

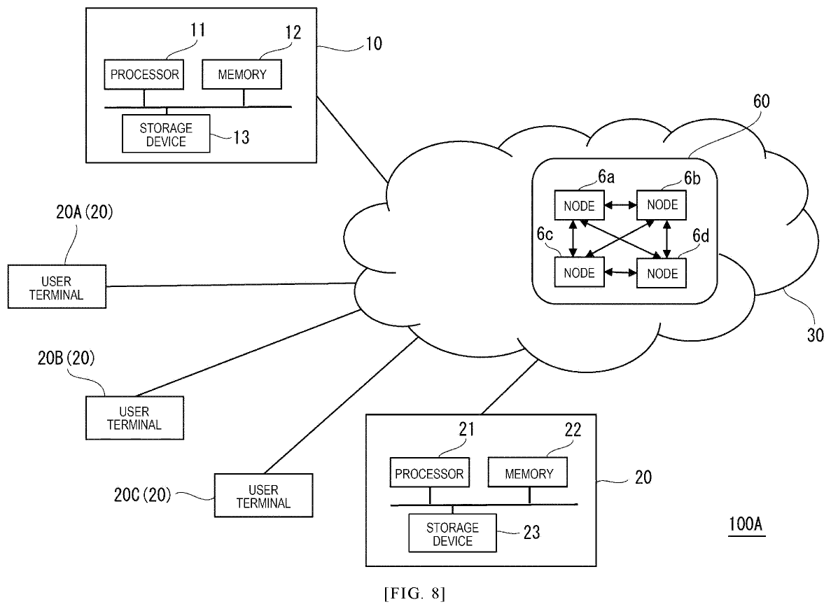

FIG. 8 is a block diagram showing an example of the configuration of a point management system 100A corresponding to at least one embodiment of the present invention. The point management system 100A, which is an example of a point management system, includes a server 10 and a user terminal 20 used by a user of the point management system 100A. User terminals 20A, 20B, and 20C are examples of user terminals 20, respectively. The configuration of the point management system 100A is not limited to this. For example, the point management system 100A may have a configuration in which a single user terminal is used by a plurality of users. The point management system 100A may have a plurality of servers.

The server 10 and the user terminal 20 are examples of computers. The server 10 and the user terminal 20 are communicably connected to a communication network 30 such as the Internet. The connection between the communication network 30 and the server 10 and the connection between the communication network 30 and the user terminal 20 may be wired or wireless. For example, the user terminal 20 may connect to the communication network 30 by performing data communication with a base station managed by a communication carrier through a wireless communication line.

The point management system 100A includes the server 10 and the user terminal 20, thereby achieving various functions for executing various processes according to user operations.

The server 10 may be a game processing server that controls the progress of a game. In this case, the server 10 controls the progress of the game according to the player's operation.

The server 10 includes a processor 11, a memory 12, and a storage device 13. The processor 11 is, for example, a central processing unit (CPU) that performs various calculations and controls. Further, when the server 10 includes a graphics processing unit (GPU), the GPU may perform some of the various calculations and controls. The server 10 uses the data read out to the memory 12 to execute various types of information processes in the processor 11, and stores the obtained processing results in the storage device 13 as necessary.

The storage device 13 has a function as a storage medium for storing various types of information. The configuration of the storage device 13 is not particularly limited, but from the viewpoint of reducing the processing load on the user terminal 20, it may be configured to store all the various types of information necessary for the control performed by the point management system 100A. Examples of such include HDDs and SSDs. However, the storage device for storing various types of information may include a storage area that can be accessed by the server 10, and may be configured to have a dedicated storage area outside the server 10, for example.

The server 10 may be configured by an information processing apparatus such as a game processing server capable of rendering game images.

The user terminal 20 is managed by the user. Examples of the user terminal 20 include mobile phone terminals, smart phones, personal digital assistants (PDAs), personal computers, tablets, stationary game devices, and portable game devices. The user terminal 20 may be user-operable VR goggles, AR glasses, smart glasses, AR contacts, or other wearable devices.

The user terminal may be a communication terminal capable of playing games distributed via a network.

The user terminal 20 is connected to the communication network 30, and includes hardware and software for executing various processes by communicating with the server 10. The plurality of user terminals 20 may be configured to be able to directly communicate with each other without going through the server 10.

The user terminal 20 may have a built-in display device. Further, a display device may be wirelessly connected or wired to the user terminal 20. It should be noted that the display device has a very general configuration, so illustration is omitted here. When the user plays a game using the user terminal 20, the game screen is displayed as a composite image on the display device, and the user recognizes this composite image. When the user performs various types of information processes using the user terminal 20, a screen necessary for information processes (information processing screen) is displayed as an image by the display device, and the user recognizes this image. The game screen and the information processing screen are displayed, for example, on a display, which is an example of a display device provided in the user terminal, or a display, which is an example of a display device connected to the user terminal. Examples of the display device include a hologram display device capable of displaying a hologram, a projection device for projecting an image (including a game screen and an information processing screen) on a screen or the like, and an XR display device. XR includes Virtual Reality (VR), Augmented Reality (AR), Mixed Reality (MR), and Substitutional Reality (SR).

The user terminal 20 includes a processor 21, a memory 22, and a storage device 23. The processor 21 is, for example, a central processing unit (CPU) that performs various calculations and controls. Further, when the user terminal 20 includes a graphics processing unit (GPU), the GPU may perform some of the various calculations and controls. The user terminal 20 uses the data read out to the memory 22 to execute various types of information processes in the processor 21, and stores the obtained processing results in the storage device 23 as necessary. The storage device 23 has a function as a storage medium for storing various types of information.

The user terminal 20 may have a built-in input device. Further, an input device may be wirelessly connected or wired to the user terminal 20. The input device receives an operation input by a user. A processor provided in the server 10 or a processor provided in the user terminal 20 executes various control processes in response to an operation input by the user. Examples of input devices include touch panel screens of smart phones, tablets, or the like, keyboards, mice, game pads, joysticks, and other controllers. A camera built in or connected to the user terminal 20 may also correspond to the input device. The user performs operation input by gestures such as moving a hand in front of the camera (gesture input).

In addition, the user terminal 20 may be equipped with other output devices such as speakers. Other output devices output sounds, vibrations, and various other types of information to the user.

The communication network 30 includes a blockchain network 60. The blockchain network 60 is constructed by a plurality of nodes such as computers. As an example of the plurality of nodes, nodes 6a, 6b, 6c, and 6d, each being a computer, are shown in FIG. 8. These are merely examples, and the number of nodes need not be four. Note that the blockchain network 60 may be constructed as a network separate from the shown communication network 30.

The plurality of nodes 6a to 6d are typically interconnected in a peer-to-peer fashion to form the blockchain network 60. A distributed ledger is stored in the storage device of each node. The server 10 or the user terminal 20 may be communicably connected to the blockchain network 60. The server 10 or the user terminal 20 may function as a node included in the blockchain network 60.

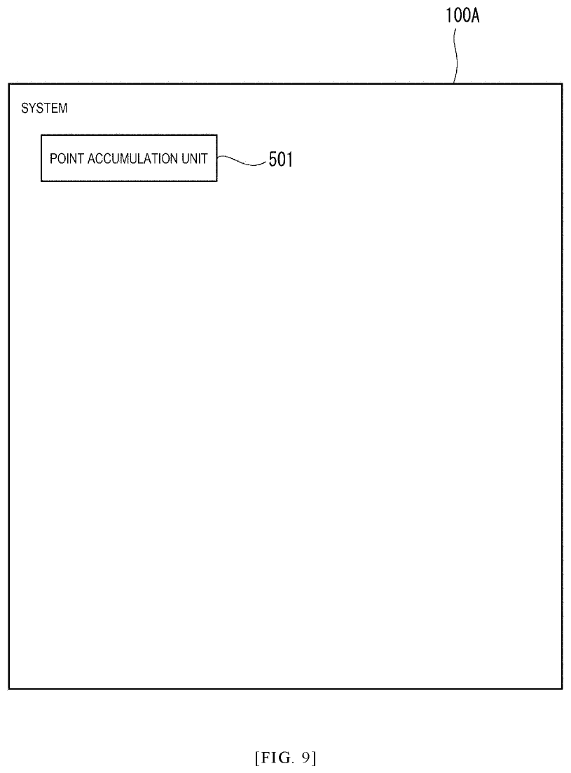

FIG. 9 is a block diagram showing the configuration of a point management system corresponding to at least one embodiment of the present invention. The point management system 100A, which is an example of the point management system, includes at least a point accumulation unit 501. One or more processors included in the point management system 100A functionally implements the point accumulation unit 501, by referring to a point management program stored in one or more storage devices included in the point management system 100A, and executing the program.

The point accumulation unit 501 has a function of accumulating points associated with a token corresponding to a user, according to predetermined conditions.

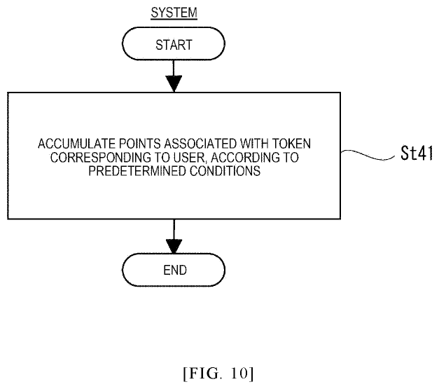

Next, a program execution process according to the fourth embodiment of the present invention will be described. FIG. 10 is a flow chart showing a processing example of a point management program corresponding to at least one embodiment of the present invention.

The point accumulation unit 501 accumulates points associated with a token corresponding to a user, according to predetermined conditions (St41).

Since the meanings of the token, the token corresponding to the user, the point associated with the token, and the predetermined condition are the same as in the first embodiment, the description is omitted from the viewpoint of avoiding duplication.

As one aspect of the fourth embodiment, it is possible to expand the usage of tokens and improve user satisfaction.

### Fifth Embodiment

An overview of a fifth embodiment of the present invention will be described. A point management program executed in a user terminal will be described below as an example of the fifth embodiment. Note that a user terminal 20X may be any one of the plurality of user terminals 20, 20A to 20C shown in FIG. 1 or FIG. 8.

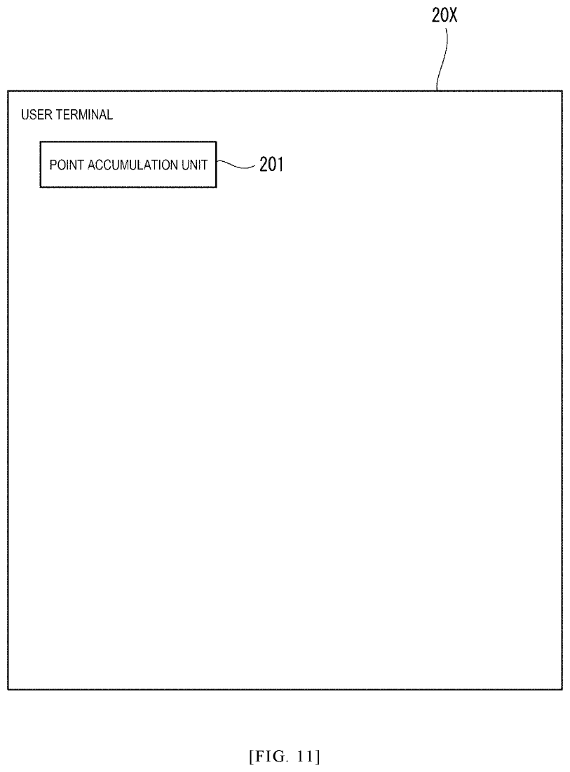

FIG. 11 is a block diagram showing the configuration of the user terminal 20X corresponding to at least one embodiment of the present invention. The user terminal 20X has at least a point accumulation unit 201. The processor provided in the user terminal 20X functionally implements the point accumulation unit 201 by referring to the point management program stored in the storage device and executing the program.

The point accumulation unit 201 has a function of accumulating points associated with a token corresponding to a user, according to predetermined conditions.

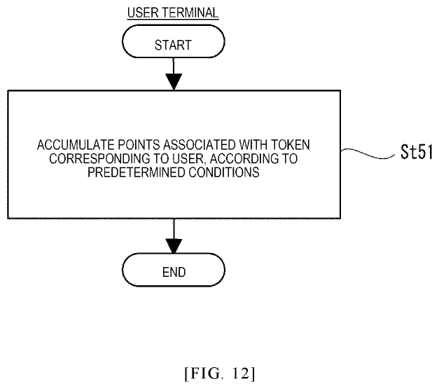

Next, a program execution process according to the fifth embodiment of the present invention will be described. FIG. 12 is a flow chart showing a processing example of a point management program corresponding to at least one embodiment of the present invention.

The point accumulation unit 201 accumulates points associated with a token corresponding to a user, according to predetermined conditions (St51).

Since the meanings of the token, the token corresponding to the user, the point associated with the token, and the predetermined condition are the same as in the first embodiment, the description is omitted from the viewpoint of avoiding duplication.

As one aspect of the fifth embodiment, it is possible to expand the usage of tokens and improve user satisfaction.

### Sixth Embodiment

An overview of a sixth embodiment of the present invention will be described. A point management program executed in a server will be described below as an example of the sixth embodiment. Note that the server may be the server 10 shown in FIG. 1 or FIG. 8.

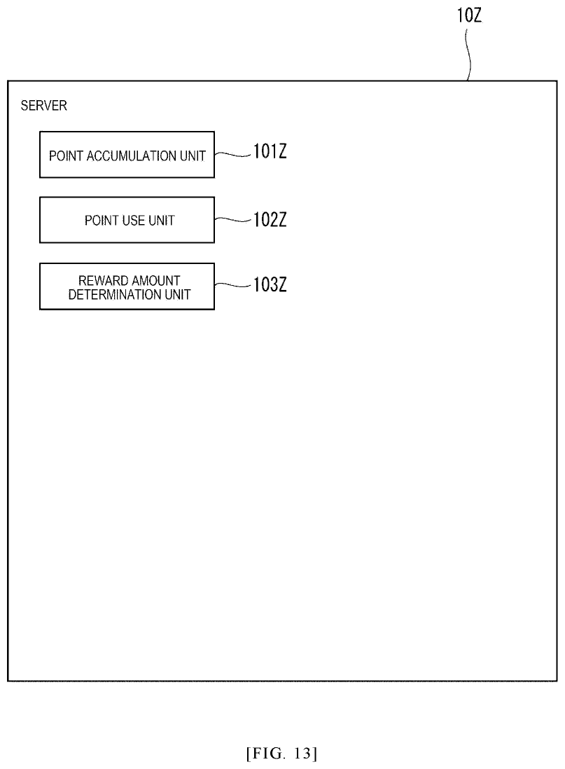

FIG. 13 is a block diagram showing the configuration of a server corresponding to at least one embodiment of the present invention. A server 10Z, which is an example of the configuration of the server 10, includes at least a point accumulation unit 101Z, a point use unit 102Z, and a reward amount determination unit 103Z. The processor provided in the server 10Z functionally implements the point accumulation unit 101Z, the point use unit 102Z, and the reward amount determination unit 103Z by referring to the point management program stored in the storage device and executing the program.

The point accumulation unit 101Z has a function of accumulating points associated with a token corresponding to a user, according to predetermined conditions. The point use unit 102Z has a function of using the points accumulated in association with the token. The reward amount determination unit 103Z has a function of determining the amount of rewards that can be provided to the user, according to a predetermined rule. The predetermined rule is determined based on the multiplication of the number of tokens to be traded and a predetermined rate.

A token typically means a non-fungible token (NFT). The token may be a fungible token (FT), a re-fungible token (RFT), or the like, as long as there is no contradiction.

The token corresponding to a user means a token issued by the user or a token owned by the user via purchase or transfer of the token. The token owned by a user means a token in which identification information for identifying the user has been written into the distributed ledger of the blockchain network as the current owner of the token. In addition, during the period when transaction information is managed off-chain, the token owned by the user may mean the token that the system manages the token owner information off-chain assuming that the user is the current owner of the token.

The point associated with a token means a digital value, which can be accumulated, stored in a storage device in association with the token.

The point associated with a token is not the token itself. For example, when the type of a token is a fungible token such as a crypto asset (virtual currency), the points associated with the token are not the crypto asset (virtual currency) itself.

The points associated with the token are managed as separate data from the crypto assets (virtual currencies) that back the token. For example, when a user or system operator converts digital assets such as shields and swords into NFTs, the issued NFTs may include crypto assets (virtual currencies) as backup. When the owner burns this NFT, the owner can obtain some or all of the crypto assets (virtual currencies) that were backed. The points associated with a token in the present embodiment mean values that are added to the token and managed, which are different from such a crypto asset (virtual currency) or the like.

The points associated with the token may not be associated with the user or the player character handled by the user in the game. For example, the points associated with the token are values managed as data separate from the player character's level, experience value, and the like.

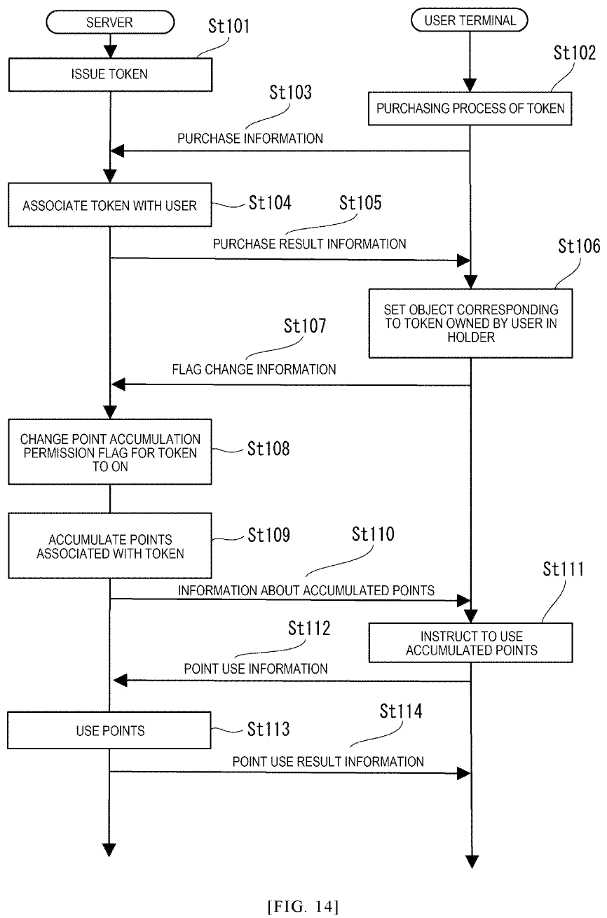

Next, a program execution process according to the sixth embodiment of the present invention will be described. FIG. 14 is a sequence diagram showing a processing example corresponding to at least one embodiment of the present invention.

The server 10Z issues one or more tokens (St101). For example, when the type of token is NFT, the NFT is issued with a blockchain account prepared on the server 10Z side. In this case, the original owner of the issued NFT is the administrator of the blockchain account. Information identifying this account is recorded on a distributed ledger located on the blockchain network 60. Note that the server 10Z may possess a token by acquiring a token that has already been issued by another party via transfer or the like.

The user operates the user terminal 20 to purchase the issued token (St102). Like various existing NFT marketplaces, the user interface for purchasing tokens such as NFT is already known, so a detailed description will be omitted.

It is also assumed that the user himself/herself is the issuer of the token. In this case, since the user already owns the token, there is no need to purchase the token. When the user himself/herself is the issuer of the token, the process of steps St102 to St105 can be omitted.

When the user purchases the token, the user terminal 20 transmits purchase information to the server 10Z (St103). The purchase information may include information for identifying the user (user identification information).

The server 10Z that has received the purchase information associates the token with the user (St104). That is, the server 10Z performs a process for writing transaction information based on the received purchase information to the distributed ledger of the blockchain network 60 such that the user who purchased the token becomes the current owner of the token.

After the transaction information is written in the distributed ledger, the server 10Z transmits the purchase result information to the user terminal 20 (St105). This purchase result information may include information indicating that the owner of the token has been switched to the user. Further, the purchase result information may include information on the token itself, address information for accessing the token, or the like.

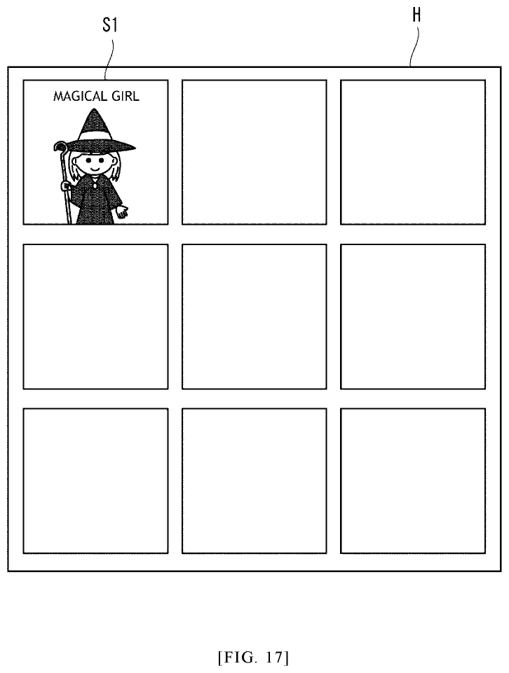

The user operates the user terminal 20 to set the object corresponding to the token owned by the user in the holder (St106). Setting an object to a holder will be described later with reference to FIG. 17.

The user terminal 20 transmits flag change information to the server 10Z (St107). The flag change information is information indicating that the point accumulation permission flag for the token has changed. In the present embodiment, the flag change information is information indicating that the point accumulation permission flag has changed from off to on.

The server 10Z changes the point accumulation permission flag for the token held by the user from off to on (St108). Thus, it becomes possible to accumulate the points associated with the token whose point accumulation permission flag is turned on.

The point accumulation unit 101Z of the server 10Z accumulates points associated with a token corresponding to a user, according to predetermined conditions (St109). The predetermined condition may be, for example, a condition of accumulating one point at 8:00 every morning, but is not limited to this.

The server 10Z transmits information about accumulated points to the user terminal 20 (St110). For example, the server 10Z transmits to the user terminal 20 information indicating that the accumulated points have increased by one point.

Note that when the point increase/decrease is managed on-chain, the process of step St110 may be omitted. In this case, the server 10Z writes information indicating the point increase/decrease to the distributed ledger of the blockchain network 60. The user can access the distributed ledger of the blockchain network 60 from the user terminal 20 at any time and check the value of the accumulated points at that time.

In addition, when the points are managed on the user terminal 20 side instead of the server 10Z side, the process of steps St107 and St110 can be omitted, and the process of steps St108 and St109 is performed on the user terminal 20 side.

The user checks the value of the point associated with the token owned by the user through the user terminal 20, and then instructs to use the points (St111).

The user terminal 20 transmits point use information to the server 10Z (St112). The point use information is, for example, information indicating what is performed by using how many of the accumulated points. The point use information in the present embodiment is information indicating how many of the accumulated points are used to increase or decrease the attribute value of the object or content data corresponding to the token to what extent.

Here, the object corresponding to the token, content data corresponding to the token, and attribute values will be described. The object corresponding to the token means a virtual object such as NFT characters and items. Specific examples of virtual objects include, but are not limited to, people, living things, vehicles, walls, buildings, towns, landforms, and stars that can be displayed in virtual space.

The object corresponding to the token may be a real object that is present in a real space. For example, when a virtual sword is converted into an NFT, the object corresponding to the token may be a sword toy or the like that is actually made to imitate the virtual sword.

The object corresponding to the token may be an electronic seal on which the above-described object is drawn, an electronic card, or the like.

The attribute values of an object are parameter values of the attribute possessed by the object, for example, physical strength, offensive power, magical power, or the like of the character object. The parameters are typically expressed as numerical values, but the parameters may also be expressed as characters, such as offensive power SS and defensive power A. The attribute value of an object is not limited to these. A change in the attribute value may be an increase or decrease in the attribute value.

Content data corresponding to a token means, for example, image data corresponding to one frame when one frame of a four-frame cartoon is tokenized. Note that the content data is not limited to one frame of a four-frame cartoon, and various types of content data such as image data, audio data, and moving image data are conceivable.

The attribute value of the content data may refer to the attribute value of any object related to the content. Further, the attribute value of the content data may mean the attribute value of the content itself.

The sequence diagram shown in FIG. 14 will be described again. The point use unit 102Z of the server 10Z that has received the point use information uses the points accumulated in association with the token (St113).

Using the accumulated points means using the accumulated points for some purpose. The use of the accumulated points is not limited, but for example, the accumulated points may be used to change the attribute value of the object or content data corresponding to the token according to the points accumulated in association with the token. Accumulated points may be used for other purposes. Note that when points are used, the balance of accumulated points may or may not decrease.

The server 10Z transmits point use result information to the user terminal 20 (St114). The point use result information is information indicating how many points and how the accumulated points were used. In the present embodiment, the point use result information is information indicating how many of the accumulated points are used to increase or decrease which attribute value of the object or content data corresponding to the token to what extent.

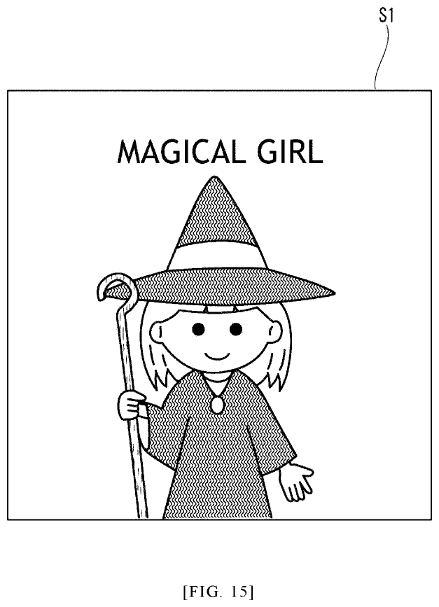

FIG. 15 is a conceptual diagram illustrating an object corresponding to a token, according to at least one embodiment of the present invention.

The object corresponding to the token in the present embodiment is the character drawn on an electronic seal S1. A wizard is drawn as a character on the shown electronic seal S1. The types of characters may vary. Further, a virtual object other than the character, such as a weapon, may be drawn on the electronic seal S1.

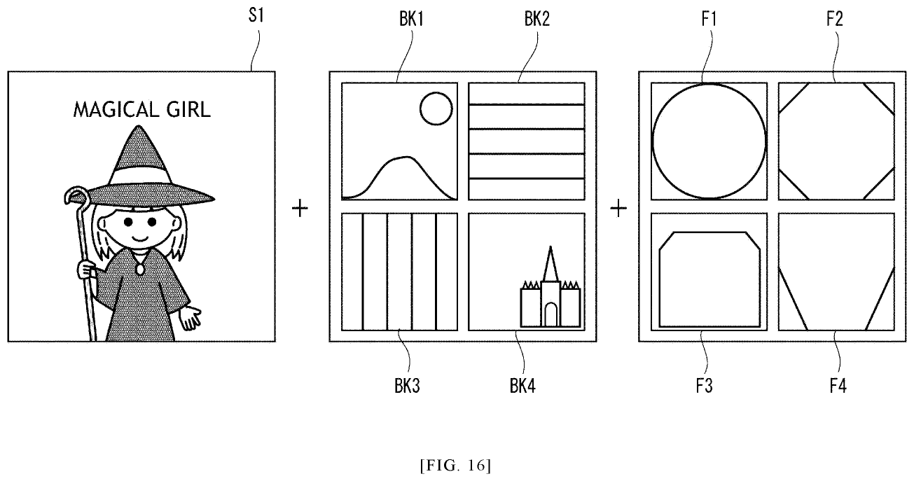

FIG. 16 is a conceptual diagram illustrating a customization process of content to be tokenized, according to at least one embodiment of the present invention. At step St102 in FIG. 14, the user has purchased a token. The user may customize the content to be tokenized and then purchase the tokens.

As an example, FIG. 16 shows an example of a customization process of selecting and combining a background and an electronic seal frame, for an image with a character drawn. The user operates the user terminal 20 to select image data on which a desired character is drawn. In the present embodiment, the user selects image data on which a wizard is drawn.

The user then selects a desired background image from a plurality of background images BK1 to BK4 displayed on the display device of the user terminal 20. Although four background images are drawn in FIG. 16, the number of selectable background images is not limited to four. The types of selectable background images are not limited to those shown in FIG. 16.

Next, the user selects a desired electronic seal frame from a plurality of electronic seal frames F1 to F4 displayed on the display device of the user terminal 20. Although four electronic seal frames are depicted in FIG. 16, the number of selectable electronic seal frames is not limited to four. The types of selectable electronic seal frames are not limited to those shown in FIG. 16.

When the user finishes selecting the character, background, and electronic seal frame, information indicating the selection result is transmitted from the user terminal 20 to the server 10Z. The server 10Z generates composite image data by combining the selected character, background, and electronic seal frame. Then, the content data corresponding to the token that has already been generated in step St101 is replaced with the generated composite image data from the original image data. Then, in step St104, the server 10Z associates the token with the user. For example, as described above, the content corresponding to the token can be customized. Note that the server 10Z may issue a token for the customized content data after the customization process shown in FIG. 16 is completed, instead of issuing the token in advance.

### Predetermined Conditions for Accumulating Points

Next, some examples of predetermined conditions for accumulating points associated with the token in step St109 of FIG. 14 will be described.

When accumulation of points for the token is permitted, the point accumulation unit 101Z may accumulate the points.

The case where accumulation of points for the token is permitted means, for example, the case where the point accumulation permission flag managed by the server 10Z or the user terminal 20 for the token is on. Various conditions for turning the point accumulation permission flag from off (for example, value=0) to on (for example, value=1) are conceivable according to specifications. For example, when an electronic seal with a character drawn is converted into an NFT, the point management system 100 or 100A may change the point accumulation permission flag from off to on, when the NFT electronic seal is set in a predetermined holder described later (see steps St106 to St108 in FIG. 14). The point management system 100 or 100A may control on/off of the point accumulation permission flag based on other conditions.

The point management system 100 or 100A separately manages permission and non-permission of point accumulation for each token. However, the point management system 100 or 100A may collectively manage permission and non-permission of point accumulation for each group composed of a plurality of tokens.

FIG. 17 is a conceptual diagram illustrating a holder H, according to at least one embodiment of the present invention. The holder H is displayed by the display device of the user terminal 20. The holder H is provided with a plurality of slots for setting electronic seals. The holder H shown in FIG. 17 is provided with a total of 9 slots of 3 vertical×3 horizontal. The number and arrangement of slots in the holder H are not limited to those shown in FIG. 17.

In step St106 of FIG. 14, the user operates the user terminal 20 to set the holder H with an object (here, electronic seal S1) corresponding to the own token. FIG. 17 shows a state where the electronic seal S1 is set in the upper left slot of the holder H.

When the electronic seal S1 is set in the holder H, the point accumulation permission flag for the token corresponding to the electronic seal S1 is changed from off to on (see steps St106 to St108).

The point accumulation unit 101Z accumulates the points associated with the token, when accumulation of points for the token is permitted, that is, when the point accumulation permission flag is turned on in the present embodiment.

The accumulation of points for one token is described above. However, the point accumulation unit 101Z may manage whether points can be accumulated for each group composed of a plurality of tokens. For example, the point accumulation unit 101Z may accumulate points associated with each token included in the group, when accumulation of points for each token included in the group to which the token belongs is permitted.

Here is a specific example. It is assumed that one adventurer group includes a hero, a warrior, and a wizard. When the first token corresponding to the hero character, the second token corresponding to the warrior character, and the third token corresponding to the wizard character are all set in the holder H, all the point accumulation permission flags for the first to third tokens may be turned on. Contrary to the above, if only the first token corresponding to the hero character and the second token corresponding to the warrior character are set in the holder H, and the third token corresponding to the wizard character is not set in the holder H, all the point accumulation permission flags for the first to third tokens may be turned off.

Next, a case where the passage of time is set as a predetermined condition will be exemplified. The point accumulation unit 101Z may accumulate points over time. The predetermined condition in this case may be, for example, the condition of accumulating one point at 8:00 every morning. In addition, various conditions according to the passage of time may be set as the above-described predetermined conditions such as accumulating points at a predetermined time every Monday, simply increasing points to be added with +1, +2, +3, or the like each time a predetermined time (for example, one week) elapses, and adding 5 bonus points when one month has passed after an object corresponding to the token is set in the holder H.

Next, a case where the number of transfers of a token is set as a predetermined condition will be exemplified. Some tokens, such as NFT, can be transferred again. In a blockchain, information is grouped into blocks and sequentially connected to the blockchain, so that transaction information can be recorded on a distributed ledger such it cannot be falsified. Therefore, information (transaction information) indicating a change in the owner of the token can be recorded in the distributed ledger of the blockchain network 60, and a change in the owner of the token that has been once issued can be managed on the blockchain.

The point accumulation unit 101Z may accumulate points, when the number of changes of the user corresponding to the token is within a predetermined range. The number of changes of the user corresponding to the token means the number of changes of owners of tokens. For example, a predetermined condition for accumulating points can be that the number of changes of the user corresponding to the token is within two times. In this case, points will be accumulated for tokens that have undergone a secondary transfer, but points will not be accumulated for tokens that have been transferred after a tertiary transfer. The predetermined range of the number of changes can be appropriately set by those skilled in the art according to the specifications in such a manner that the number of changes is up to 1 time, 0 to 3 times, 2 to 4 times, or the like.

Next, a case where an address is set as a predetermined condition will be exemplified. The point accumulation unit 101Z may accumulate points when the address indicating the owner of a token is a predetermined address.

The owner of a token means the issuer of a token or a person who acquires a token via transfer or the like. The address indicating the owner of a token means an address by which the owner can be identified. For example, an address for identifying an account in a blockchain, such as an address starting with “0x” in the Ethereum blockchain or an address starting with “link” in the LINE blockchain, corresponds to the address that indicates the owner of the token here.

By managing whether points can be accumulated, according to the address of the owner of the token, when a person who set the token in the holder H is the issuer of the token or a person who has the power to attract customers (celebrity, or the like), points can be accumulated.

Note that the token owner may be a previous owner. For example, when the token set in the holder H was once held by a person who has the power to attract customers (celebrity, or the like), points can be accumulated. Note that the server 10Z may acquire information on previous owners, from previous transaction information recorded in the distributed ledger of the blockchain network 60.

### Use Example of Points

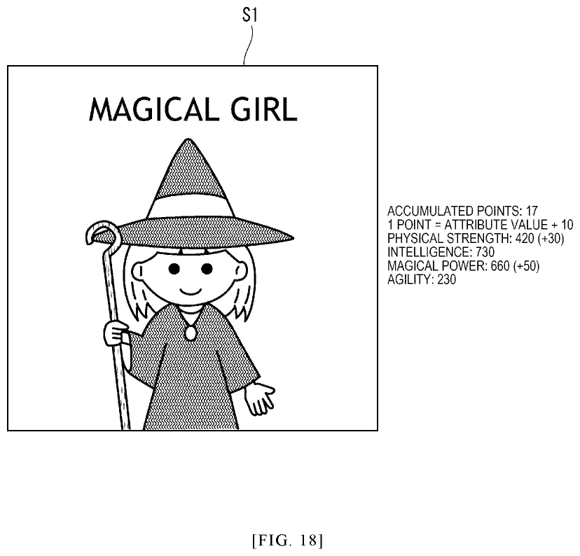

The following are use examples of accumulated points. FIG. 18 is a conceptual diagram showing a use example of points, according to at least one embodiment of the present invention.

It is assumed that the physical strength, intelligence, magical power, and agility of the character drawn on the electronic seal S1 are defined as the attribute values of the electronic seal S1. The initial values of the four parameters are 420 for physical strength, 730 for intelligence, 660 for magical power, and 230 for agility.

At step St111 in FIG. 14, the user instructs to use the accumulated points via the user terminal 20. Here, it is assumed that 17 points are accumulated that are associated with the token corresponding to the electronic seal S1. Further, in the present embodiment, it is assumed that one of the four attribute values of the electronic seal Si can be increased by 10 per point.

The user instructs to use 8 points among the accumulated 17 points. More specifically, the user instructs to use 3 points for physical strength and 5 points for magical power. The point use information based on the user's point use instruction is transmitted from the user terminal 20 to the server 10Z (step St112).

The point use unit 102Z of the server 10Z that has received the point use information uses 8 points that have been accumulated in association with the token to increase the physical strength of the electronic seal S1 by 30 and the magical power by 50. Note that the degree of change in the attribute value per point (+10 in the present example) may be appropriately set by those skilled in the art according to the specifications.

### Determination of Amount of Rewards

Next, determination of the amount of rewards based on accumulated points will be described. The point management system 100 or 100A can provide rewards, such as ranking rewards, based on the accumulated points.

The types of rewards are not particularly limited. The rewards may be, for example, digital data, real-world items, or some benefits provided to the user. The rewards may be another token, for example. That is, based on the points accumulated in association with a token A, the user can acquire a token B as a reward. However, the reward complies with a predetermined law about giving rewards to users.

An example of a predetermined law in Japan is the Premiums and Misleading Representations Act. Here, the premium is considered to be one aspect of the reward. As for premiums, the maximum amount of premiums, the upper limit of the total amount of premiums, or the like may be determined.

Therefore, from a legal compliance point of view, the point management system 100 or 100A cannot provide an unlimited number of rewards to users.

Therefore, the reward amount determination unit 103Z determines the amount of rewards that can be provided to the user, according to a predetermined rule. That is, the reward amount determination unit 103Z determines an appropriate amount of rewards that fits within the upper limit of the total premium amount.

The predetermined rule used by the reward amount determination unit 103Z may be determined based on the multiplication of the number of tokens to be traded and a predetermined rate.

For example, it is defined that the upper limit of the total premium amount is 2% of the total planned sales amount for the prize. In this case, the predetermined ratio would be 0.02.

The number of tokens to be traded means the number of tokens (initial inventory of tokens) provided by the administrator or the like of the point management system 100 or 100A.

Here, not all tokens are transferred from the administrator or the like of the point management system 100 or 100A to the user. Therefore, the number of tokens to be traded may mean a value obtained by multiplying the initial inventory of tokens by the transfer rate. For example, when the initial inventory of tokens is 50,000 and the transfer rate (sales rate) is 80%, the number of tokens to be traded is 50,000×0.8=40,000.

In the case of the above embodiment, the reward amount determination unit 103Z determines 40,000×0.02=800 as the amount of rewards that can be provided to the user.

The predetermined rule used by the reward amount determination unit 103Z is based on the premise that the transaction value of each token and the evaluation value of the reward are the same amount. On this premise, for example, when all 50,000 tokens are traded for 500 yens, the token provided as a reward (premium) is also assumed to have an evaluation value equivalent to 500 yens.

As one aspect of the sixth embodiment, it is possible to expand the usage of tokens and improve user satisfaction.

As one aspect of the sixth embodiment, it is possible to flexibly control whether to accumulate points for each token.

As one aspect of the sixth embodiment, it is possible to determine whether points can be accumulated for each group to which the token belongs.

As one aspect of the sixth embodiment, the value of tokens with which points are associated can be increased over time.

As one aspect of the sixth embodiment, it is possible to manage whether points can be accumulated, according to the utilization of tokens that can be transferred again, by controlling whether points can be accumulated, according to the number of transfers of the token.

As one aspect of the sixth embodiment, it is possible to flexibly manage whether points can be accumulated, according to the type of the owner of the token (the issuer of the token, celebrity, or the like).

As one aspect of the sixth embodiment, by making it possible to use the points accumulated in association with the token, it is possible to expand the range of utilization of tokens and provide new enjoyment to users.

As one aspect of the sixth embodiment, it is possible to provide users with various ways of playing using objects or content data corresponding to tokens.

As one aspect of the sixth embodiment, an appropriate number of rewards can be determined.

As described above, the embodiments of the present application address one or more deficiencies. In addition, the effect by each embodiment is a non-limiting effect or an example of an effect.

In each of the above-described embodiments, the user terminal 20 and the server 10 execute the various processes described above according to various control programs (for example, point management programs) stored in their own storage devices. In addition, other computers that are not limited to the user terminal 20 and the server 10 may execute the above-described various processes according to various control programs (for example, point management programs) stored in their own storage devices.

Further, the configurations of the point management systems 100 and 100A are not limited to the configurations described as examples of the above-described embodiments. For example, the server may execute some or all of the processes described as the processes executed by the user terminal, or the user terminal may execute some or all of the processes described as the processes executed by the server. Further, a configuration in which the user terminal may include part or all of the storage unit (storage device) included in the server may be used. That is, in the point management systems 100 and 100A, one of the user terminal and the server may have some or all of the functions provided by the other.

Further, the program may be configured to cause a single device that does not include a communication network implement part or all of the functions described as examples of the above-described embodiments.

### Note

The above descriptions of the embodiments describe at least the following inventions such that those having ordinary knowledge in the field to which the inventions belong can implement the inventions.

[1]

A point management program causes a computer to implement a point accumulation function of accumulating points associated with a token corresponding to a user, according to a predetermined condition.

[2]

The point management program described in [1], in which in the point accumulation function, when accumulation of the points for the token is permitted, a function of accumulating the points is implemented.

[3]

The point management program described in [2], in which in the point accumulation function, when accumulation of the points for each token included in a group to which the token belongs is permitted, a function of accumulating the points associated with each token included in the group is implemented.

[4]

The point management program described in any one of [1] to [3], in which in the point accumulation function, a function of accumulating the points over time is implemented.

[5]

The point management program described in any one of [1] to [4], in which in the point accumulation function, when the number of changes of the user corresponding to the token is within a predetermined range, a function of accumulating the points is implemented.

[6]

The point management program described in any one of [1] to [5], in which in the point accumulation function, when an address indicating an owner of the token is a predetermined address, a function of accumulating the points is implemented.

[7]

The point management program described in any one of [1] to [6], in which the computer is caused to implement a point use function of using the points accumulated in association with the token.

[8]

The point management program described in [7], in which in the point use function, a function of changing an attribute value of an object or content data corresponding to the token, according to the points accumulated in association with the token is implemented.

[9]

The point management program described in any one of [1] to [8], in which the computer is further caused to implement a reward amount determination function of determining an amount of rewards to be provided to the user, according to a predetermined rule, and the predetermined rule is determined based on multiplication of the number of tokens to be traded and a predetermined rate.

[10]

The point management program described in any one of [1] to [9], in which the token is a non-fungible token.

[11]

A program causing a user terminal capable of communicating with a server to implement at least one of functions that the point management program according to any one of [1] to [10] causes the server to implement.

[12]

A computer in which the point management program according to any one of [1] to [10] is installed.

[13]

A point management system including a communication network, a server, and a user terminal, including: point accumulation means for accumulating points associated with a token corresponding to a user, according to a predetermined condition.

[14]

A point management method by a computer, the method including: a point accumulation process of accumulating points associated with a token corresponding to a user, according to a predetermined condition.

[15]

A point management method by a system including a communication network, a server, and a user terminal, including: a point accumulation process of accumulating points associated with a token corresponding to a user, according to a predetermined condition.

### INDUSTRIAL APPLICABILITY

According to one embodiment of the present invention, the present invention is useful as a point management program, a point management system, and a point management method that expand the usage of tokens and improve user satisfaction.

### REFERENCE SIGNS LIST

10, 10A, 10B, 10C, 10Z server
11 processor
12 memory
13 storage device
20, 20A, 20B, 20C, 20X user terminal
21 processor
22 memory
23 storage device
30 communication network
60 block chain network
100, 100A point management system
101A, 101B, 101Z, 201, 501 point accumulation system
102C, 102Z point use unit
103Z reward amount determination unit
BK1, BK2, BK3, BK4 background image
F1, F2, F3, F4 electronic seal frame
H holder
S1 electronic seal

1. A non-transitory computer readable medium storing a point management program including computer-executable instructions for causing a computer to execute:
accumulating points associated with a token corresponding to a user, according to a predetermined condition.

2. The non-transitory computer readable medium according to claim 1, wherein
the accumulating points associated with the token is executed upon permission of accumulation of the points for the token.

3. The computer readable medium according to claim 1, wherein
the accumulating points associated with the token is executed over time.

4. The computer readable medium according to claim 1, wherein
the accumulating points associated with the token is executed when the number of changes of the user corresponding to the token is within a predetermined range.

5. The computer readable medium according to claim 1, wherein
the accumulating points associated with the token is executed when an address indicating an owner of the token is a predetermined address.

6. The computer readable medium according to claim 1, wherein the computer-executable instructions further comprise
using the points accumulated in association with the token.

7. The computer readable medium according to claim 6, wherein
the using the points associated with the token comprises changing an attribute value of an object or content data corresponding to the token, according to the points accumulated in association with the token.

8. A point management system comprising a communication network, a server, and a user terminal, the point management system comprising:
a processor configured to accumulate points associated with a token corresponding to a user, according to a predetermined condition; and
a storage device configured to store the accumulated points.

9. A computer-implemented point management method, the method comprising:
accumulating points associated with a token corresponding to a user by a computer, according to a predetermined condition.
